(19) United States
(12) Patent Application Publication
(10) Pub. No.: US 2007/0227292 A1
(43) Pub. Date: Oct. 4, 2007

(54) Custom steering wheels

(76) Inventor: Ramelle Rollins, Fresno, CA (US)

Correspondence Address: Ramelle O. Rollins, 2445 E Northdale, Fresno, CA, 93726, US

(21) Appl. No.: 11/274,515

(22) Filed: Nov. 4, 2005

(51) Int. Cl. B62D 1/04

(52) U.S. Cl. 74/552

(57) ABSTRACT

The custom steering wheel for motor vehicles has a hub, a steering wheel rim and 72-100 spokes connecting the steering wheel rim with the hub. The hub comprises a hub core for fastening to the steering wheel shaft and a body which surrounds the hub core and is mae of a metal or aluminum alloy. The spokes are integrally and continuously molded with the spokes from a aluminum alloy material. The steering wheel rim is integrally and continuously molded with the spokes from an aluminum alloy. In this arrangement, the base together with the spokes and the steering wheel rim forms a self-supporting shaped body.

### REFERENCES CITED

U.S. Patent Document

| | | |
|---|---|---|
| 1847414 | March 1932 | Smith. |
| 3394615 | July 1968 | Brueder. |
| 4386538 | June 1983 | Van Wicklin, Jr. |
| 6098286 | August 2000 | Kreuzer |
| 6244620 | June 2001 | Bathon et al. |
| 6491319 | December 2002 | Bonn |
| 6682682 | January 2004 | Drefahl |

### SUMMARY OF INVENTION

By the invention of a custom steering wheel for motor vehicle is made available which fully or almost completely does away with the steering wheel skeleton that would increase the manufacturing expense. The custom steering wheel according to the invention has a hub, a steering wheel rim and 72-100 spokes connecting the steering rim with the hub. The hub comprises a hub core for fastening to a steering shaft and a base body which surrounds the hub core and is made of a metal material. The spokes are integategally and continuously molded with the base body of the hub from a metal alloy material. The custom steering wheel rim is continuously molded with the spokes from a aluminum alloy material. The base body together with the spokes and the steering wheel rim forms a self-supporting shaped body. The invention provides a method for the manufacture of the custom steering wheel. The exceptional feature of the method is that the hub core of the steering wheel is placed in a mold and a mass consisting of an aluminum alloy material introduced into the mold. The mass is introduced without pressure into and open form tool part preferably by means of a program-controlled and movable injection head. When injection of the mass is complete and prior to forming up the latter, the mold is closed. The hand cushion can be purchased from commercial venders.

The second embodiment of this invention can be made by the same process, with the exception that the core, rim, and the body of the custom steering wheel will be one piece. This method makes it possible for the custom steering wheel too be made to match the wheel or rim design, i.e. stars, blades or ovals or standard wheel designs. The hand grip remains the same.

### DETAILED DESCRIPTION OF THE INVENTION

The conventional steering wheel for motor vehicles, has a hub, a steering wheel rim and a plurality of spokes connecting the steering wheel rim with the hub. The hub forms in the region of transition to the spokes, a shoulder for the supporting and fastening of a gas bag module.

FIG. 1 shows the embodiment of the custom steering wheel and according to the invention in which the steering skeleton is completely eliminated. The hub 6 consists of a hub core 17 in the shape of a metal bush and a base body 15, the latter surrounding the hub core 6 and extending up to the shoulder 18. The base body 6 together with the spokes 4 and the steering wheel rim 3 constitutes a shaped body made of a metal alloy material. Manufacture of the custom steering is preferable done by a special molding method in which the metal mass is introduced without pressure into an open form tool introducing the metal mass is effected by means of a movable injection nozzle, which is directed along the cavity of the tool part, in particular in a program-controlled manner.

Suitable plastic or rubber material are used to form the hand cushion (these hand cushion can be purchased from commercial venders.) In the preferred embodiment of the method plastic or rubber material is formed in the shape of a low profile tire attached to the steering wheel rim.

On application of the method described, there results a custom steering wheel with a shaped body, in which the region near the outer surface are arranged predominately paralleled to the outer surface. The shaped body has the mechanical properties, in particular its flexural strength subjected to tensile and compressive stress.

In the embodiment shown in FIG. 4, the hub 6 is reinforced by a metallic reinforced insert 15 Which is connected with the bush-shaped core 15 and extended up to the shoulder 18. The reinforcing insert 17 serves mainly for the supporting and mounting of a gas bag module. For this, the ends of the reinforcing insert 17 are configured in the region of the shoulder 18 as fastening element, e.g. in the nature of nuts 14, which are flush with the surface of the shoulder 18. In the embodiment shown in FIG. 4, the reinforcing insert is replaced by a mounting structure 13 which at its outer end comprises in the region of the shoulder 18 fastening element 8 such as nuts. The reinforcing inserts 17 in the embodiment according to 6 or the mounting structure 17 in the embodiment according to FIG. 4 is placed into the cavity of the form tool prior to introducing the metal alloy mass together with the hub core 6. The reinforcing insert and the mounting structure 17, respectively, are embedded in the shaped body after introducing the alloy mass.

### BRIEF DESCRIPTION OF THE DRAWINGS

Further features and advantages of the read from the following description of several embodiments and from the drawing to which reference made in which:

FIG. 1 shows a front view of the custom steering wheel, without horn or air bag assembly.

FIG. 2 shows a front view of the custom steering wheel with horn and air bag assembly.

FIG. 3 shows an exploding view of the custom steering wheel of the first embodiment of the invention.

FIG. 4 shows an exploding view of hub assembly.

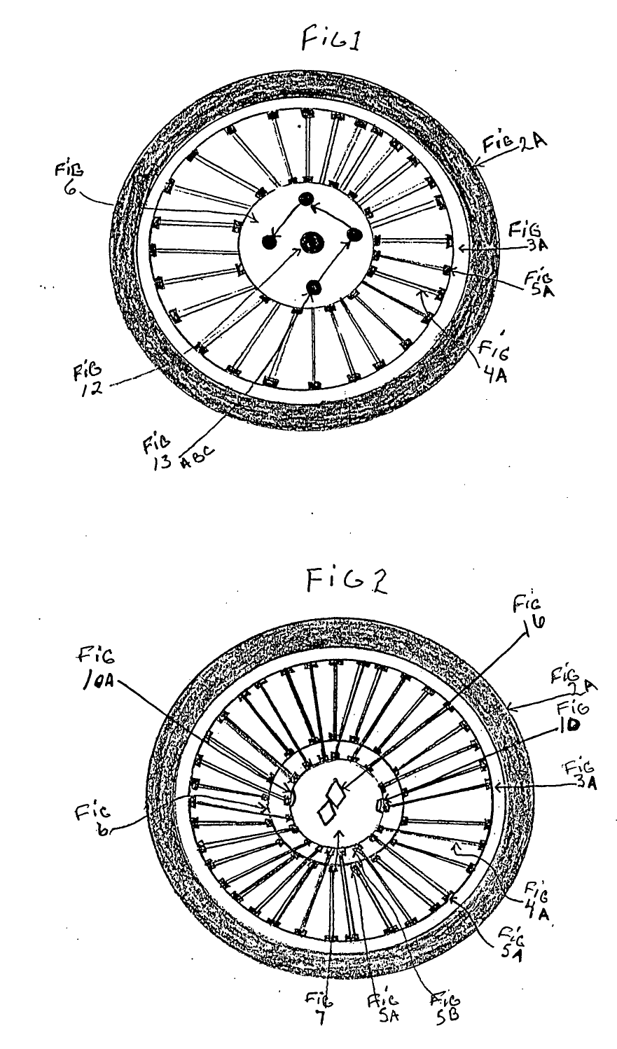

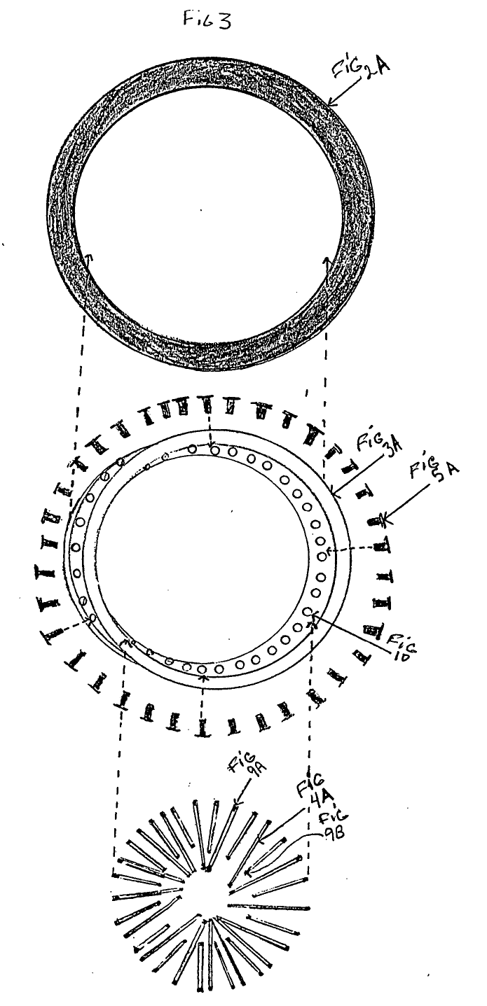

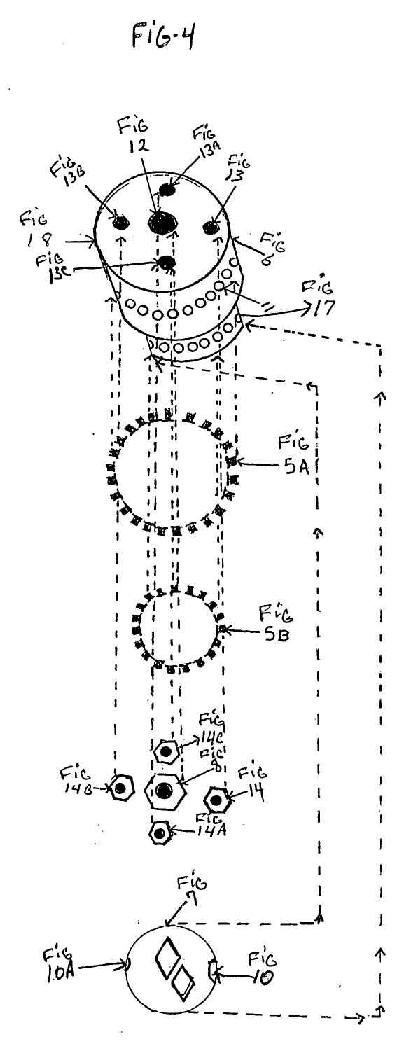

FIG. shows an exploding view of the second embodiment of the custom steering wheel.

What is claimed:

1. A customized steering wheel for motor vehicles, comprising a hub, a steering wheel rim with multiple spokes ranging from 72 to 100, connecting the steering wheel rim with the hub, the hub comprising a hub core for fastening to a steering shaft and a base body which surround the hub core, the base body being made of a polished aluminum material the spokes extending from a region of transition between the base body of the husband the spokes, the spokes being integrally and continuously molded with the base body of the hub from a aluminum alloy material, the base body together with the spokes and the steering wheel rim forming a self-supporting shaped body, wherein at the region of transition, the base body of the hub forms a shoulder for supporting a gas bag module, the base body comprising a reinforced insert extending from the hub core to the region of transition and embedded in said body, the reinforcing insert having ends in the region of transition configured as fastening elements for contact with the gas bag module and having end surface not imbedded in said base body and exposed, the end surfaces which are not embedded being for fastening to the gas bag module.

2. The customized steering wheel according to claim 1, wherein the hub core and the reinforcing insert are made of cast iron.

3. The customized steering wheel according to claim 1, wherein the metal material of the shaped body is selected from the group consisting of Aluminum, magnesium or cast iron.

4. The customized steering wheel according to claim 3, wherein the aluminum material is formed.

5. A customized steering wheel for motor vehicles, comprising a hub, a steering wheel rim and 72 to 100 spokes connecting the steering wheel rim with the hub, and a rubber or synthetic material that forms a hand cushion, with the appearance of a low profile tire.

6. A customized steering wheel that can be molded to match any tire or wheel design, where the steering wheel ring, hub core and body are one piece; i.e. stars, blades or standard wheel designs.

7. A customized steering wheel according to claim 5 wherein a rubber or synthetic material forms a hand cushion, with the appearance of a low profile tire.
